(19) United States
(12) Patent Application Publication
(10) Pub. No.: US 2002/0070615 A1
(43) Pub. Date: Jun. 13, 2002

(54) High-speed electric machine

(76) Inventors: Ralf Jakoby, Unterbozberg (CH); Michael Jung, Waldshut-Tiengen (DE); Markus Lebong, Niederrohrdorf (CH)

Correspondence Address: BURNS DOANE SWECKER & MATHIS L L P, POST OFFICE BOX 1404, ALEXANDRIA, VA, 22313-1404, US

(21) Appl. No.: 09/930,191

(22) Filed: Aug. 16, 2001

(30) Foreign Application Priority Data
Aug. 23, 2000 (EP) 00810752.6

(51) Int. Cl. H02K 9/00

(52) U.S. Cl. 310/58

(57) ABSTRACT

A high-speed electric machine (10), comprises a rotatably mounted rotor (11) which, separated by an air gap (14), is surrounded concentrically by a stator (12) with two winding overhangs (18,19), and comprises means (20, . . . ,29) for cooling the rotor (11) and stator (12), by means of which a cooling medium, especially cooling air, is sent on a circuit through the rotor (11) and the stator (12), and the heat picked up by the cooling medium or the cooling air in the process is extracted again in a cooler (20).

In such a machine, improved and more cost-effecting cooling is achieved by the cooling medium or the cooling air being guided on two largely mutually independent, preferably parallel, first and second cooling circuits (24 and 25) for the stator (12) and the rotor (11).

### TECHNICAL FIELD

The present invention relates to the field of electric machines. It relates to a high-speed electric machine according to the preamble of claim 1.

### PRIOR ART

The cooling of high-speed electric machines, in particular asynchronous motors in the power range from 1 to 20 MW, places high requirements on the selection of a suitable cooling concept, and also on the design of the individual components, because of the high circumferential speeds of the rotor. The electric power loss to be dissipated generally reaches values, even in the rotor, which require internal cooling. Dissipating heat solely via the air gap between rotor and stator and via the end faces of the rotor is often inadequate in order to comply with the limiting temperature values determined by the respective insulation class.

In this case, a special position is assumed by machines which can be cooled by a medium under high pressure. This includes, for example, motors for driving pipeline compressors, which are integrated into the natural gas line and through which the conveyed medium (methane) flows under a pressure between 40 and 70 bar. In this case, under certain circumstances it is possible to dispense with cooling the interior of the rotor.

In applications which need a flow through the rotor, two opposed requirements have to be met, which are of critical importance in particular at rotor circumferential speeds in the transonic range. Firstly, reliable dissipation of heat has to be ensured by the necessary provision of an adequate cooling medium mass flow. This is opposed by the requirement to limit the ventilation losses which are proportional to the mass flow and to the second or third power of the rotor circumferential speed and which can significantly impair the overall efficiency of the machine. Furthermore, as it flows through the rotor, the cooling medium can be heated in such a way that the exit temperature is above the permissible material temperature of the stator. It is therefore not possible to use the established cooling schemes of standard machines which operate in the speed range between 3000 and 3600 rev/min and which provide for serial flow through the rotor and stator.

### PRESENTATION OF THE INVENTION

It is therefore an object of the invention to specify a cooling concept, for cooling high-speed electric machines or asynchronous machines, which permits both efficient dissipation of the heat output and extensive minimization of the ventilation losses. Furthermore, this concept is also intended to achieve considerable advantages with regard to the operating costs of the machine.

The object is achieved by the whole of the features of claim 1. The core of the invention consists in the use of largely mutual independent cooling circuits for rotor and stator. In this way, each of the two components is supplied with cold cooling medium or cooling air. An inflow of already heated air from the rotor into the stator or vice-versa, which is associated with mostly high losses, is therefore not required, which on the one hand permits efficient cooling of both components to be achieved, and also a reduction in the fluidic losses as compared with conventional cooling concepts.

A preferred configuration of the invention is characterized by the fact that in order to circulate the cooling medium or the cooling air an additional fan which can be controlled independently of the machine is connected upstream or downstream of the cooler, and compensates for the pressure losses which arise in the stationary components.

A further preferred refinement of the invention is distinguished by the fact that the cooling medium or the cooling air in the second cooling circuit for cooling the rotor flows through axial cooling ducts accommodated in the rotor, and in that in order to compensate for the pressure losses produced while flowing through the rotor, a blade system is fitted to the rotor. The blade system is preferably arranged on the end of the rotor facing the incoming cooling medium.

According to a further preferred refinement of the invention, in order to cool the stator, radial cooling slots are provided in the stator and are subdivided by tangential segmentation into slot segments, wherein, by means of a collecting and distributing device arranged at the back of the stator in the first cooling circuit, each slot segment is supplied with cold cooling medium from the cooler and heated cooling medium is guided away from the slot segment and back to the cooler, and the cooling medium within the slot segments flows from the outside to the inside in one half segment, is deflected underneath the conductor bars of the stator and flows out of the slot segment again in a second half segment. In particular, in this case the cooling slots of the stator are sealed off with respect to the air gap.

Furthermore, it is advantageous if a third cooling circuit is connected in parallel with the first and second cooling circuits and is used as a means of cooling the winding overhang on the end of the stator facing the incoming cooling medium and of flushing the air gap.

Further embodiments emerge from the dependent claims.

### BRIEF EXPLANATION OF THE FIGURES

The invention is to be explained in more detail below using exemplary embodiments in connection with the drawing, in which

FIG. 1 shows a schematic longitudinal section of a preferred exemplary embodiment of a cooled electric machine according to the invention; and

FIG. 2 shows a cross section of an exemplary segmented stator cooling of the machine according to FIG. 1.

### WAYS OF IMPLEMENTING THE INVENTION

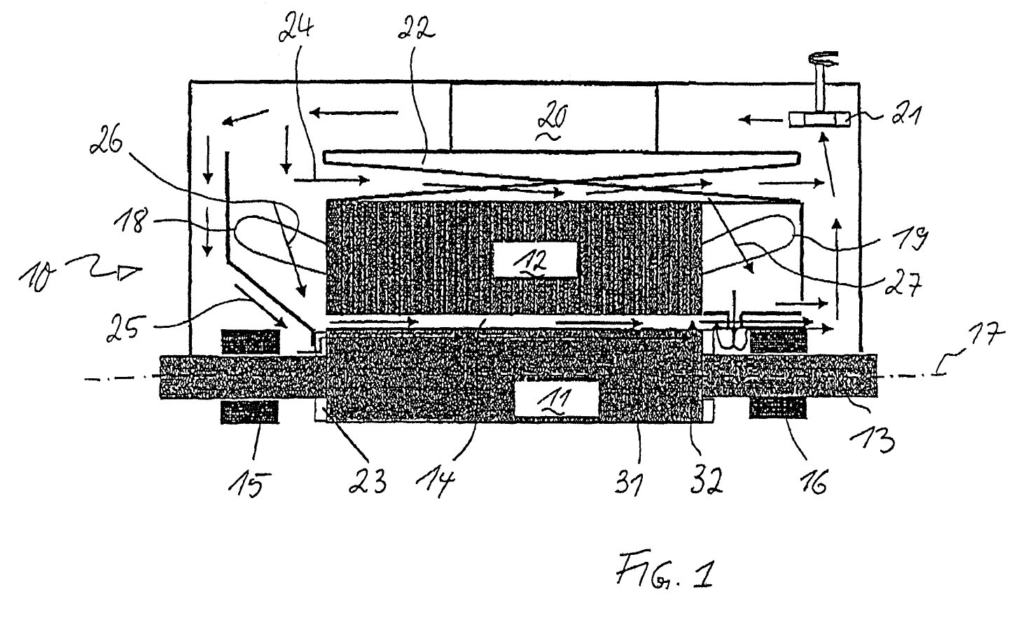

FIG. 1 shows a schematic longitudinal section of a preferred exemplary embodiment of a high-speed, cooled electric machine according to the invention. The electric machine 10 comprises a rotor 11, which is mounted in two bearings 15 and 16 by a rotor shaft 13 such that it can rotate about an axis of rotation 17. The rotor 11 is surrounded coaxially by a stator 12 which is provided at the ends with winding overhangs 18 and 19 and of which, in FIG. 1, for reasons of simplicity, only the upper half is shown. Rotor 11 and stator 12 are separated from each other by an air gap 14. Arranged in the upper region of the machine 10 is a cooler 20, through which a cooling medium, preferably air, flows. The flow of the cooling air through the cooler 20 is effected by an additional fan 21 which, in the example shown, is placed upstream of the cooler 20 in the flow direction, but can also be arranged downstream of the cooler 20.

A significant feature of the cooling concept according to the invention is, then, the use of two largely mutual independent cooling circuits 25 and 24 for the rotor 11 and stator 12. In this way, each of the two components is supplied with cold air. The inflow of already heated air from the rotor 11 into the stator 12 or vice-versa, which is associated with mostly high losses, is therefore not required, which firstly permits the efficient cooling of both components to be achieved, and also a reduction in the fluidic losses as compared with conventional cooling concepts.

In parallel with the paths of the rotor or stator air (cooling circuits 25 and 24), there is an additional cooling circuit 26, via which the winding overhang 18 on the cold gas side is cooled and the air gap 14 is flushed. Uncontrolled heating of the air in the interior of the air gap 14 is therefore avoided, and the frictional output, which is considerable in the case of machines with a high circumferential speed, is dissipated. In addition, a throttling element (e.g. a labyrinth seal) (not illustrated in FIG. 1) for regulating the air gap mass flow can be fitted at the inlet or the outlet of the air gap.

Furthermore, there is preferably a fourth cooling circuit 27, via which the winding overhang 19 on the “hot” machine side is supplied with cold air.

The cooling concept sketched in FIG. 1 has two pressure sources: the external additional fan 21, which can be controlled independently of the machine 10 and which is connected upstream or downstream of the cooler 20, compensates for the pressure losses arising in the stationary components, while an impeller (blading system 23) fitted to the rotor 11 compensates for the pressure losses arising from the flow through the rotor.

In the case of machines with high circumferential speeds, the entry of the cooling medium into the rotor 11 is always a critical component. High differential speeds between the fluid and the rotating wall can cause significant flow separations and therefore high pressure losses. These exceed the pressure built up by the external fans (21) conventionally used, under certain circumstances by a multiple, so that the mass flow required for the cooling can ultimately not be fed into the rotor 11. In order, firstly, to keep the entry losses as low as possible and, secondly, also to produce a build-up of pressure which compensates for the friction losses in the rotor 11, a radial or diagonal blade system 23 fastened to the shaft 13 is fitted at the “cold” end of the active rotor part. The flow through the rotor 11, and its cooling, are carried out through axial cooling ducts 31, which open into a radial exit gap 32 at the “hot” machine end of the rotor 11.

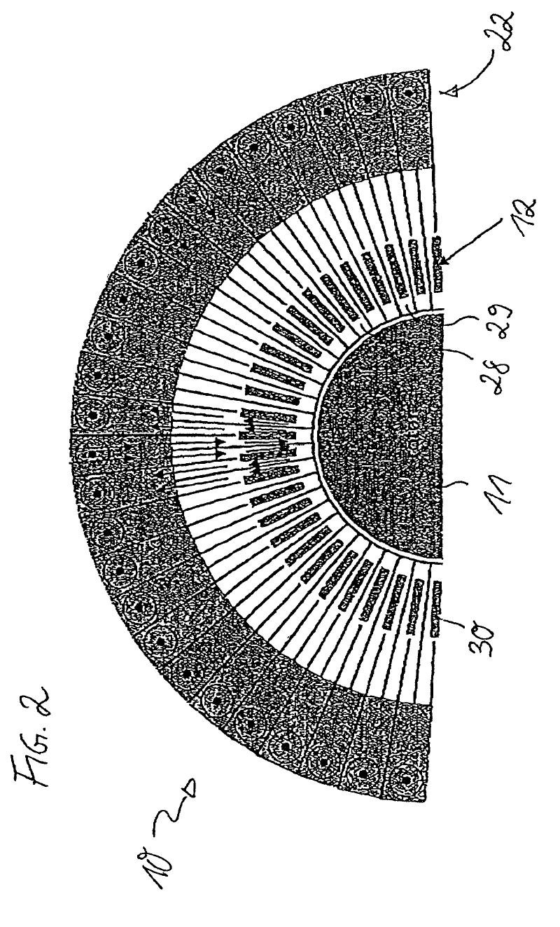

In the cooling of the stator 12, in principle various concepts can be employed, but are intended to have, as a “common denominator”, a means of sealing them off from the air gap 14, so that the separation of the rotor and stator cooling medium flows (cooling circuit 24, 25) is ensured. The principle is to be shown here using the example of “tangential” segmentation of the radial cooling slots of the stator 12 (FIG. 2). This intrinsically offers an asymmetrical cooling concept, since the air management can be configured very flexibly and easily integrated into the overall concept. The inflow and the outflow of the collecting and distributing ducts fitted to the rear of the stator by means of a collecting and distributing device 22 can in principle be placed on any desired side of the machine.

Furthermore, this cooling scheme produces a very homogeneous temperature distribution in the stator 12.

The supply of cooling air and the discharge of the heated air are carried out by the collecting and distributing ducts (22) on the rear of the stator, already mentioned and sketched in FIG. 2. The distributors are fed from the “cold” machine side, while the collectors discharge the air to the “hot” side (cf. FIG. 1). Starting from the cold air distributors, in each case one half of a slot segment 28, 29 is flowed through from the outside to the inside (arrows in FIG. 2). Underneath the conductor rods 30 of the stator 12, a deflection through 180° takes place, and then the outflow into the warm air collector. Here, it is to be noted that the stator slots have to be sealed off with respect to the air gap 14. This can be implemented, for example, by means of a cylindrical insert (“air-gap cylinder”).

Overall, the invention results in a cooling concept for a high-speed electric machine which permits both efficient dissipation of the heat output and extensive minimization of the ventilation losses. In addition, this concept also results in considerable advantages with regard to the operating costs of the machine, since the cooling with air can be carried out under atmospheric conditions and not, as in the case of machines already available on the market, with helium under pressure of about 4 bar or with methane under 40-70 bar.

LIST OF DESIGNATIONS

| | |
|---|---|
| 10 | Electric machine (high speed) |
| 11 | Rotor |
| 12 | Stator |
| 13 | Rotor shaft |
| 14 | Air gap |
| 15, 16 | Bearing (rotor) |
| 17 | Axis of rotation |
| 18, 19 | Winding overhang |
| 20 | Cooler |
| 21 | Additional fan |
| 22 | Collecting and distributing device |
| 23 | Blade system |
| 24, . . . , 27 | Cooling circuit |
| 28, 29 | Slot segment |
| 30 | Conductor rod (stator) |
| 31 | Cooling duct (axial) |
| 32 | Outflow gap (radial) |

1. A high-speed electric machine (10), comprising a rotatably mounted rotor (11) which, separated by an air gap (14) is surrounded concentrically by a stator (12) with two winding overhangs (18,19), and comprising means (20, . . . ,29) for cooling the rotor (11) and stator (12), by means of which a cooling medium, especially cooling air, is sent on a circuit through the rotor (11) and the stator (12), and the heat picked up by the cooling medium or the cooling air in the process is extracted again in a cooler (20), characterized in that the cooling medium or the cooling air is guided on two largely mutually independent, preferably parallel, first and second cooling circuits (24 and 25) for the stator (12) and the rotor (11).

2. The machine as claimed in claim 1, characterized in that in order to circulate the cooling medium or the cooling air, an additional fan (21) which can be controlled independently of the machine (10) is connected upstream or downstream of the cooler.

3. The machine as claimed in either of claims 1 and 2, characterized in that the cooling medium or the cooling air in the second cooling circuit (25) for cooling the rotor (11) flows through axial cooling ducts (31) accommodated in the rotor (11), and in that in order to compensate for the pressure losses produced while flowing through the rotor, a blade system (23) is fitted to the rotor (11).

4. The machine as claimed in claim 3, characterized in that the blade system is arranged on the end of the rotor (11) facing the incoming cooling medium.

5. The machine as claimed in one of claims 1 to 4, characterized in that in order to cool the stator (12), radial cooling slots are provided in the stator (12) and are subdivided by tangential segmentation into slot segments (28,29), in that by means of a collecting and distributing device arranged on the back of the stator (12) in the first cooling circuit (24), each slot segment (28,29) is supplied with cold cooling medium from the cooler (20) and heated cooling medium is guided away from the slot segment (28,29) and back to the cooler (20), and in that the cooling medium within the slot segments (28,29) flows from the outside to the inside in one half segment, is deflected underneath the conductor bars (30) of the stator and flows out of the slot segment (28,29) again in a second half segment.

6. The machine as claimed in claim 5, characterized in that the cooling slots of the stator (12) are sealed off with respect to the air gap (14).

7. The machine as claimed in one of claims 1 to 6, characterized in that a third cooling circuit (26) is connected in parallel with the first and second cooling circuits (24,25) and is used as a means of cooling the winding overhang (18) on the end of the stator (12) facing the incoming cooling medium, and of flushing the air gap (14).

8. The machine as claimed in claim 7, characterized in that at the inlet and/or the outlet of the air gap (14) there is arranged a throttling element to regulate the mass flow of the cooling medium through the air gap (14).

9. The machine as claimed in one of claims 1 to 8, characterized in that a fourth cooling circuit (27) is provided, by means of which the winding overhang (19) on the end of the stator (12) facing away from the incoming cooling medium is supplied with cooling medium.
